(19) United States
(12) Patent Application Publication
(10) Pub. No.: US 2017/0050505 A1
(43) Pub. Date: Feb. 23, 2017

(54) EASY SETUP COOL CAR COVER

(71) Applicant: XIAMEN EASEPAL ENTERPRISES LTD., XIAMEN (CN)

(72) Inventor: ZHIYONG YU, XIAMEN (CN)

(73) Assignee: XIAMEN EASEPAL ENTERPRISES LTD., XIAMEN (CN)

(21) Appl. No.: 15/159,813

(22) Filed: May 20, 2016

(30) Foreign Application Priority Data
Aug. 18, 2015 (CN) 201520622395.9
Aug. 25, 2015 (CN) 201520646015.5

(51) Int. Cl. B60J 11/04

(52) U.S. Cl. CPC B60J 11/04

(57) ABSTRACT

The present invention is provided with an Easy Setup Cool Car Cover, which is disposed with a car cover main body, a fixing cloth, fixing belts and a fiberglass pole; the fixing cloth is set at the rear end of the main body; the central portion of the fixing cloth is disposed with an opening, the fixing cloth is placed in the car trunk with the Velcro; the main body is designed to cover the full car, at the bottom of the main body is disposed with elastic cord, a pocket is designed at the front of the main body, the bottom of the main body is disposed with several fixing belts, the fixing belt is disposed with a hook. The present invention is available and suitable for many types of cars, like sedan, hatchback, SUV, even the minivans, and it can also be quickly assembled by one person.

### FILED OF THE INVENTION

The present invention relates to a car cover, especially to a easy setup cool car cover.

### BACKGROUND OF THE INVENTION

The car covers in the existing market are inconvenient to install, especially for one person, besides, exiting car covers need steel cable and lock for anti-theft, and the existing car covers have congenital defect that people need to buy different size of car cover base on the vehicle type and length.

### SUMMARY OF THE INVENTION

The object of the present invention is to overcome the disadvantages of the existing known technology and provides a Easy setup cool car cover that is available and general to cars of different type, and it can also be quickly assembled by one person.

The technical proposal of the present invention to solve the technical problems is that: a Easy setup cool car cover, which is disposed with a car cover main body, a fixing cloth, fixing belts and a fiberglass pole; the fixing cloth is set at the rear end of the main body; the central portion of the fixing cloth is disposed with an opening, the fixing cloth is placed in the car trunk with the Velcro, the opening designed on the fixing cloth makes the trunk closed smoothly; the main body is designed to cover the full car, at the bottom of the main body is disposed with elastic cord, a pocket is designed at the front of the main body, the cool car cover is installed on the car easily by putting the fiberglass pole in the pocket and dragging from end to front; the bottom of the main body is disposed with several fixing belts, the fixing belt is disposed with a hook that can keep the car cover stay still in the big wind.

In another preferred embodiment, the opening of the fixing cloth is disposed with a zipper, the opening size and the location of the Velcro on the rear surface of the fixing cloth contacted to the trunk can be designed according to the car size.

In another preferred embodiment, the closing direction of the zipper of the fixing cloth is from the rear end of the fixing cloth to connecting position of the fixing cloth and the main body.

In another preferred embodiment, the fixing belts are length adjustable.

In another preferred embodiment, the car cover main body has two layers of material, the upper layer is made of PET aluminum film, the lower layer is made of soft non-woven fabrics.

In another preferred embodiment, the pole is foldable.

In another preferred embodiment, the pole is length adjustable.

In another preferred embodiment, the fixing cloth is disposed with a storage strip, when the car cover is rolled to store, the storage strip is used to bind and fix the rolled car cover.

The present invention has advantages:

1. the Velcro of the fixing cloth and the zipper opening at the center can provide well fixing effect, and it is available and applicable in different cars, it also has anti-theft function;

2. with the fiberglass pole, one person can pull it to assemble the car cover;

3. the elastic cords at the side of the car cover main body can make the car cover available for different cars, and they also have fixing and anti-wind functions;

4. the main body has two layers of material, so that it can not only reflect the sunlight and protect the paintwork of the car, but also make the main body durable.

The present invention will be further described with the drawings and the embodiments, but it should be noted that the scope of the claim is not limited to the embodiments.

### BRIEF DESCRIPTION OF THE DRAWINGS

FIG. 1 illustrates a schematic diagram of the present invention.

FIG. 2 illustrates a schematic diagram of the fixing cloth of the present invention.

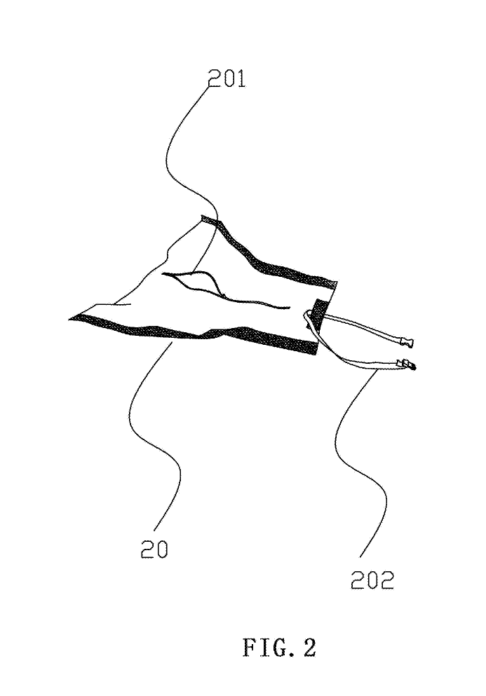

FIG. 3 illustrates a schematic diagram of the present invention after folded.

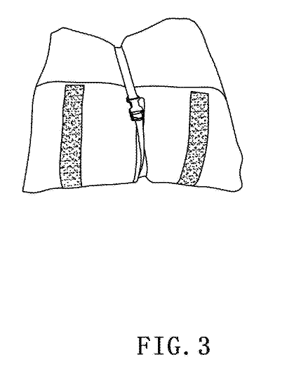

FIG. 4 illustrates a schematic diagram of the present invention when it is assembled to a sedan car.

FIG. 5 illustrates a schematic diagram of the present invention when it is assembled to a cart.

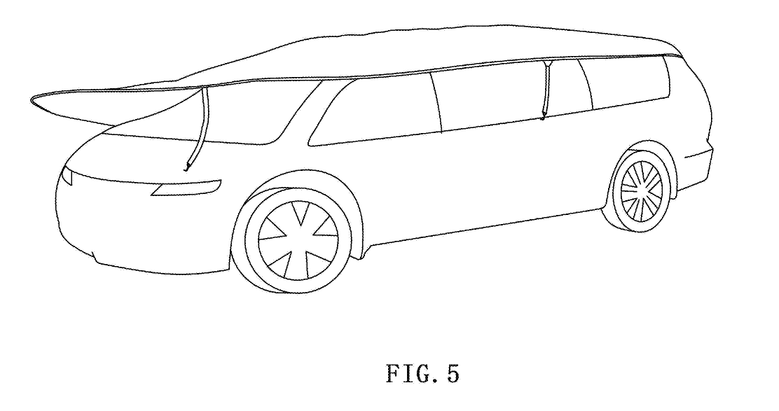

### DETAILED DESCRIPTION OF THE EMBODIMENTS

The preferred embodiment:

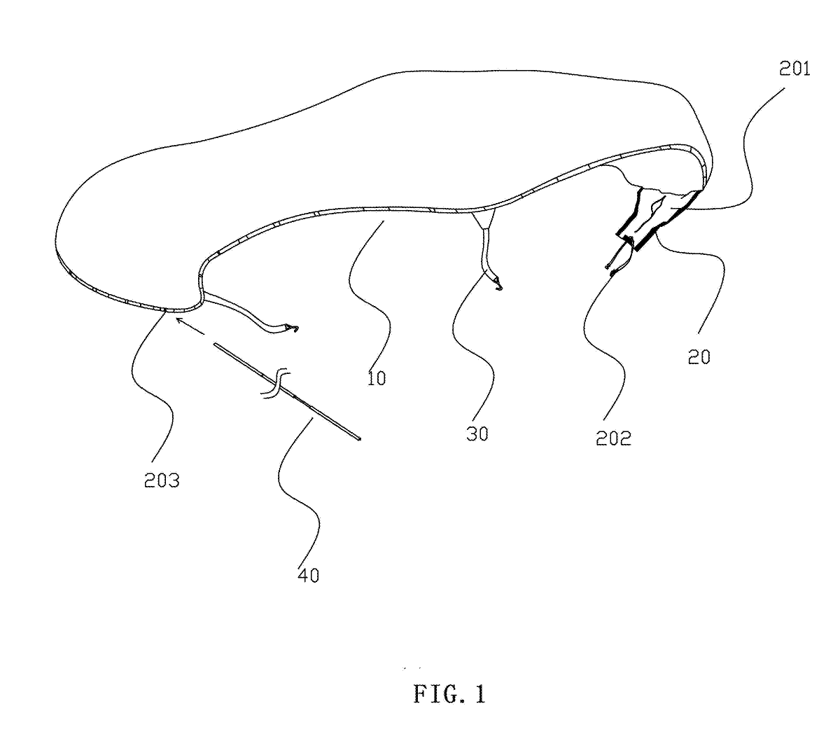

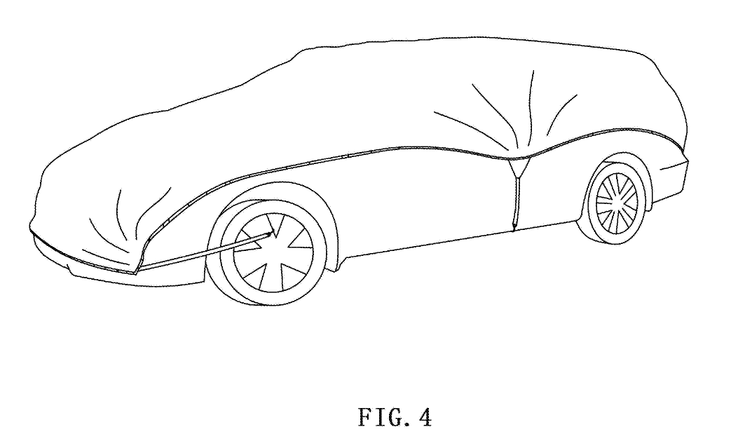

Please referring to FIG. 1˜FIG. 4, an Easy setup cool car cover comprises a car cover main body 10, a fixing cloth 20, fixing belts 30 and a fiberglass pole 40;

the fixing cloth 20 is disposed at the rear end of the main body 10; the central portion of the fixing cloth 20 is disposed with an opening 201, the fixing cloth 20 is disposed in the car trunk with the Velcro, the opening 201 designed on the fixing cloth 20 will make the trunk closed smoothly; the main body is designed to cover the full car, at the bottom of the main body is disposed with elastic cords, a pocket 203 is disposed at the front of the main body, the cool car cover can be installed on the car easily by putting the fiberglass pole 40 in the pocket 203 and dragging from end to front; the bottom of the main body 10 is disposed with a plurality of fixing belts 30, the fixing belt 30 is disposed with a hook that can keep the car stay still in the big wind.

The elastic cords at the periphery of the main body 10 can make the car cover main body more contact with the car and prevent the car cover blew away by wind.

When used, firstly the fixing cloth 20 is fastened and fixed into the car trunk, one end of the pole 40 is inserted to the pocket 203 at the front end of the main body 10, pulling the other end of the pole 40 can make the car cover fully cover the car, it is convenient for one person to assemble the car cover. After the car cover fully covers the car, the hooks of the elastic cords 30 hook to the car bottom or the car handles or the car wheel hub to fix the car cover according to the actual situation. After the car cover is fixed, the pole 40 in the pocket 203 of the main body 10 is taken away or not as needed. If the car is large and high, the fixing belts 20 at two sides of the car cover can firstly fix to the corresponding sides of the car, and then the fixing belts 20 are fixed to the handles or the wheel hub according to the car size; the pole is pulled to make the car cover fully cover the car, then the fixing bends 20 at the other side of the car cover are fixed.

Preferred, the opening 201 of the fixing cloth 20 is disposed with a zipper, the opening size and the location of the Velcro on the rear surface of the fixing cloth contacted to the trunk can be designed according to the car size.

Preferred, the closing direction of the zipper of the fixing cloth 20 is from the rear end of the fixing cloth 20 to connecting position of the fixing cloth 20 and the main body 10, thus preventing the trunk cover from extruding the zipper when it is put down.

Preferred, the fixing belts are length adjustable, so that it is suitable for cars with different size.

Preferred, the car cover main body 10 has two layers of material, the upper layer is made of PET aluminum film, the lower layer is made of soft non-woven fabrics. It can not only reflect the sunlight, but also protect the paintwork of the car.

Preferred, the pole 40 is foldable.

Preferred, the pole 40 is length adjustable.

Preferred, the fixing cloth 20 is disposed with a storage strip 202, when the car cover is rolled to store, the storage strip 202 is used to bind and fix the rolled car cover.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. An easy setup cool car cover comprising:
a car cover main body;
a fixing cloth;
fixing belts; and
a fiberglass pole;
wherein the fixing cloth is set at the rear end of the main body; the central portion of the fixing cloth is disposed with an opening, the fixing cloth is placed in the car trunk with an Velcro, the opening designed on the fixing cloth makes the trunk closed smoothly; the main body is designed to cover the full car, at the bottom of the main body is disposed with elastic cord, a pocket is designed at the front of the main body, the cool car cover is installed on the car easily by putting the fiberglass pole in the pocket and dragging from end to front; the bottom of the main body is disposed with several fixing belts, the fixing belt is disposed with a hook that can keep the car cover stay still in the big wind.

2. The easy setup cool car cover according to claim 1, wherein the opening of the fixing cloth is disposed with a zipper, the opening size and the location of the Velcro on the rear surface of the fixing cloth contacted to the trunk can be adjusted according to the length of the car.

3. The easy setup cool car cover according to claim 2, wherein the closing direction of the zipper of the fixing cloth is from the rear end of the fixing cloth to connecting position of the fixing cloth and the main body.

4. The easy setup cool car cover according to claim 1, wherein the fixing belts are length adjustable.

5. The easy setup cool car cover according to claim 1, wherein the car cover main body has two layers of material, the upper layer is made of PET aluminum film, the lower layer is made of soft non-woven fabrics.

6. The easy setup cool car cover according to claim 1, wherein the fiberglass pole is foldable.

7. The easy setup cool car cover according to claim 1, wherein the pole is length adjustable.

8. The easy setup cool car cover according to claim 1, wherein the fixing cloth is disposed with an adjustable strap, when the car cover is rolled to store, the adjustable strap is used to bind and fix the rolled car cover.
